(19) United States
(12) Patent Application Publication
(10) Pub. No.: US 2026/0162663 A1
(43) Pub. Date: Jun. 11, 2026

(54) METHOD, APPARATUS, DEVICE, MEDIUM AND PRODUCT FOR WAKING UP DEVICE

(71) Applicant: Beijing Zitiao Network Technology Co., Ltd., Beijing (CN)

(72) Inventor: Kungui ZHANG, Beijing (CN)

(21) Appl. No.: 19/417,132

(22) Filed: Dec. 11, 2025

(30) Foreign Application Priority Data
Dec. 11, 2024 (CN) 202411823578.7

(51) Int. Cl. G10L 15/22; G10L 15/08

(52) U.S. Cl. CPC G10L 15/22; G10L 15/08; G10L 2015/088; G10L 2015/223

(57) ABSTRACT

Embodiments of the disclosure relate to a method, an apparatus, a device, a medium and a product for waking up a device. The method comprises determining a received audio input from a user at a first device. The method further comprises determining that the received audio input represents a first evaluation result for a part of a wake-up command for the first device. The method further comprises, in response to the first evaluation result being greater than a threshold, providing the received audio input and a subsequent audio input corresponding to another part of the wake-up command to a second device to determine whether to wake up the first device. The method further comprises waking up the first device in response to receiving from the second device an instruction to wake up the first device.

### CROSS-REFERENCE TO RELATED APPLICATION(S)

This application claims priority to Chinese Application No. 202411823578.7 filed Dec. 11, 2024, the disclosure of which is incorporated herein by reference in its entirety.

### FIELD

Embodiments of the disclosure generally relate to the field of device management, and specifically to a method, an apparatus, a device, a medium and a product for waking up a device.

### BACKGROUND

At present, application of a speech interaction technology in smart device is increasingly prevailing, particularly in a wearable device such as a Bluetooth earphone, or a smart loudspeaker.

### SUMMARY

Embodiments of the present disclosure provide a method, an apparatus, a device, a medium and a product for waking up a device.

In a first aspect of the present disclosure, there is provided a method for waking up a device. The method comprises determining a received audio input from a user at a first device. The method further comprises determining that the received audio input represents a first evaluation result for a part of a wake-up command for the first device. The method further comprises, in response to the first evaluation result being greater than a threshold, providing the received audio input and a subsequent audio input corresponding to another part of the wake-up command to a second device to determine whether to wake up the first device. The method further comprises waking up the first device in response to receiving from the second device an instruction to wake up the first device.

In a second aspect of the present disclosure, there is provided an apparatus for waking up a device. The apparatus comprises an audio input receiving module configured to determine a received an audio input from a user at a first device; a wake-up command evaluation module configured to determine that the received audio input represents a first evaluation result for a part of a wake-up command for the first device; an audio input forwarding module configured to, in response to the first evaluation result being greater than a threshold, provide the received audio input and a subsequent audio input corresponding to another part of the wake-up command to a second device to determine whether to wake up the first device; and a device wake-up module configured to wake up the first device in response to receiving from the second device an instruction to wake up the first device.

In a third aspect of the present disclosure, there is provided an electronic device, comprising: at least one processor; and a storage device for storing at least one program which, when executed by the at least one processor, cause the at least one processor to implement the method in the first aspect of the present disclosure.

In a fourth aspect of the present disclosure, there is provided a computer readable storage medium having stored thereon a computer program which, when executed by a processor, implements the method in the first aspect of the present disclosure.

In a fifth aspect of the present disclosure, there is provided a computer program product. The computer program product comprises a computer program which, when executed by a processor, implements the method in the first aspect of the present disclosure.

It should be appreciated that the content described in Summary part is not intended to define essential or important features of embodiments of the present disclosure or to limit the scope of the present disclosure. Other features of the present disclosure will be made apparent by the following description.

### BRIEF DESCRIPTION OF THE DRAWINGS

The above and other objects, features and advantages of the present disclosure will become more apparent by reference to the following more detailed description of example embodiments of the present disclosure in conjunction with the accompanying drawings, wherein the same reference numerals usually denote the same parts in the example embodiments of the present disclosure.

FIG. 1 illustrates a schematic diagram of an example environment in which an apparatus and/or a method according to some embodiments of the present disclosure may be implemented;

FIG. 2 illustrates a schematic diagram of an example method for waking up a device according to some embodiments of the present disclosure;

FIG. 3 illustrates a schematic diagram of an example process of a device-application interaction flow according to some embodiments of the present disclosure;

FIG. 4 illustrates a schematic block diagram of an apparatus for waking up a device according to some embodiments of the present disclosure;

FIG. 5 illustrates a schematic block diagram of an example device adapted to implement multiple embodiments of the present disclosure.

### DETAILED DESCRIPTION OF EMBODIMENTS

For a user, the fluency of human-computer interaction is particularly important. Therefore, it becomes a focus of many developers'research to improve the communication efficiency between the user and the smart device in a human-machine interaction scenario. The developers are dedicated to constantly enhance the user's experience in the human-machine interaction by improving the interaction efficiency between the smart device and the user.

With the constant development of wearable devices, it is usually believed that a main research method is to reduce a wake-up speed of the wearable devices in human-machine interaction. As for the user, the wearable device may respond quickly and the user waits for the wake-up of the wearable device for a shorter period of time, which may significantly enhance the user's overall experience in the human-machine interaction process.

It may be appreciated that data (including but not limited to the data itself, acquisition or use of data) involved in the technical solution should comply with requirements in relevant laws and regulations and relevant provisions.

It is to be understood that, before the technical solutions disclosed in the embodiments of the present disclosure are used, a user should be informed of a type, a use range, a use scenario, etc. of personal information involved in the present disclosure and authorization should be obtained from the user in an appropriate manner according to relevant laws and regulations.

For example, when the user's active request is received, prompt information is sent to the user to explicitly prompt the user that the operation requested to be performed will require the acquisition and use of his personal information. Accordingly, the user may autonomously decide according to the prompt information whether to provide his personal information to software or hardware, such as an electronic device, an application, a server or a storage medium, which performs the operation of the technical solution of the present disclosure.

As an optional but non-limiting implementation, a manner of sending the prompt information to the user in response to receiving the user's active request may for example be a pop-up window in which the prompt information may be presented in a text. In addition, the pop-up window may also carry a selection control for the user to select “agree” or “disagree” to provide or not provide the personal information to the electronic device.

It may be appreciated that the above process of notifying and acquiring the user's authorization is merely illustrative and not intended to limit implementations of the present disclosure, and that other manners satisfying relevant laws and regulations may also be applied to implementations of the present disclosure.

Hereinafter, embodiments of the present disclosure will be described in more detail with reference to the figures. Although some embodiments of the present disclosure are shown in the figures, it is to be understood that the present disclosure may be implemented in various forms and should not be construed as being limited to the embodiments illustrated herein; rather, these embodiments are provided to enable more thorough and complete understanding of the present disclosure. It should be appreciated that the drawings and embodiments of the present disclosure are for illustrative purposes only and are not intended to limit the scope of the present disclosure.

In the description of the embodiments of the present disclosure, the term “include” or like words should be considered as being open-ended, i.e., “include but not limited to”. The term “based on” should be understood as meaning “based at least in part on”. The terms “one embodiment” or “the embodiment” should be understood as “at least one embodiment”. The terms “first”, “second” and the like may refer to different or identical objects unless expressly stated otherwise. Other explicit and implicit definitions may also be included below.

Usually, in a human-machine interaction process, a user generally speaks a wake-up word actively to activate a device and trigger interaction. However, a small wake-up model can only be built in a Bluetooth earphone due to limitation of computing resources. In order to ensure a higher wake-up rate and a lower false wake-up rate, it is necessary to put a larger secondary model in the application on a mobile terminal for a secondary verification. Therefore, when a wake-up event is detected on the earphone, an audio needs to be transmitted via Bluetooth to an application, and a conclusion on whether the wake-up is successful is transmitted to the earphone after the completion of the processing by the application. The earphone may play a prompt sound to enable the user to perceive that the wakeup is successful. However, due to the influence from the Bluetooth transmission efficiency, a large delay occurs in the process of transmitting the audio to the mobile terminal for verification. For example, due to the limitation of Bluetooth bandwidth, it takes about 180 ms to pass an audio of an averagely 1-second, 4-syllable wake-up word through the Bluetooth channel to the application. This will cause the user to feel a perceived latency becomes larger (the perceived latency is defined as a time gap between finishing speaking the wake-up word and perceiving a successful wake-up), thereby reducing the user's efficiency in the smart interaction and affecting the user's experience.

To this end, embodiments of the present disclosure provide a method for waking up a device. In the method, a first device receives an audio input from a user. Then, a determination is made at the first device that the received audio input from the user represents a first evaluation result for a part of a wake-up command for the first device. If the first evaluation result is greater than a threshold, which indicates that the received audio input is very probably the part of the wake-up command, the received audio input and a subsequent audio input corresponding to another part of the wake-up command may be provided to a second device to determine whether to wake up the first device. If an instruction is received from the second device to wake up the first device, the second device is woken up. By this method, the audio is sent to the mobile terminal in advance by moving up a pre-wake-up time, effectively moving up the start time of sending the audio to the mobile terminal, thereby enabling the mobile terminal to receive all the audio faster, reducing the waiting time for the user to wake up the device, and also reducing the lag perceived by the user, and improving the user's experience. In other words, by this method, the time for transmitting the audio is controlled, the transmitting process is moved up, a latency of a link is optimized, an interaction latency perceived by the user is effectively reduced, and the user's experience is improved

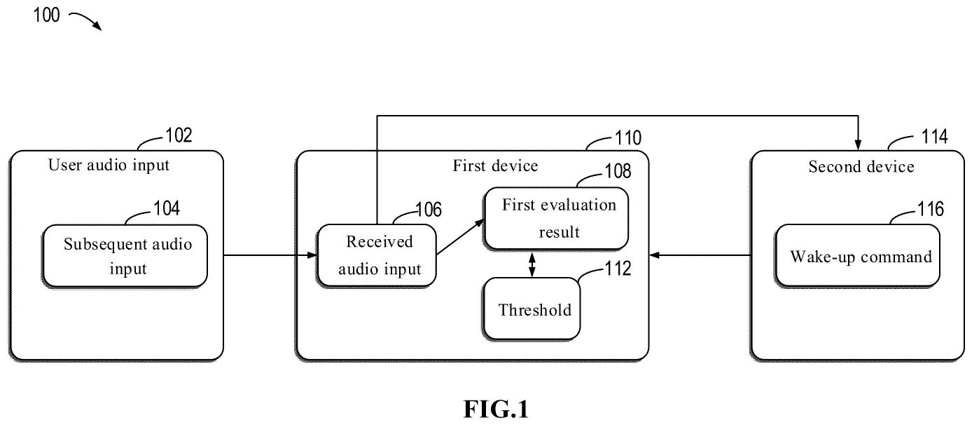

Embodiments of the present disclosure will be described in further detail below with reference to the figures. FIG. 1 illustrates an example environment in which an apparatus and/or a method according to some embodiments of the present disclosure may be implemented. In an environment 100, through a detection of pre-wake-up of the audio, a first device 110 may be enabled to provide a received audio input corresponding to a wake-up command to a second device 114 as early as possible for verification.

The first device 110 may be a wearable device such as a Bluetooth earphone, a smart watch, a smart bracelet, smart glasses, a smart garment, etc. Examples of the second device 114 include, but are not limited to, a personal computer, a server computer, a handheld or laptop device, a mobile device (such as a mobile telephone, a Personal Digital Assistant (PDA), a media player, etc.), a multiprocessor system, a consumer electronics product, a minicomputer, a mainframe computer, a distributed computing environment that comprises any of the above systems or devices, and the like.

As illustrated in FIG. 1, when the user needs to wake up the first device 110, he generally needs to speak out a wake-up command such as a wake-up word or sentence, i.e., a corresponding user audio input 102, required to wake up the corresponding device. For example, when the user needs to wake up the first device, if the wake-up command is the four words “wake up the device”, the user may divide it into two parts, i.e., an already-spoken part and a to-be-spoken part, while he speaks out the four words one by one. The already-spoken part is received in real time by the first device 110 (e.g., a Bluetooth earphone or smart glasses, etc.) and taken as the received audio input 106. The received audio input 106 is evaluated in the first device 110. Thus, the already-received audio input 106 may be acquired in the first device 110 as a first evaluation result 108 for a part of a pre-wake-up instruction for the first device 110. Additionally, the first evaluation result here is implemented in the first device by an audio processing model. For example, on the premise that the wake-up word is “wake up the device”, a pre-wake-up event may be provided in advance when the user has not yet finished speaking out the wake-up word. A traditional scheme is to transmit the audio after it is determined that the user has finished spoking out the complete wake-up command, whereupon the audio input needs to be compared with a higher wake-up threshold to determine whether the audio input is the wake-up command, for example, the wake-up threshold is 0.9. However, in the present disclosure, the wake-up threshold for the wake-up command is set to a value smaller than the traditional wake-up threshold, e.g., the wake-up threshold may be set to 0.5. Therefore, when part of the audio corresponding to the wake-up command is detected, the audio input may be determined as the wake-up command. For example, when the first device 110 receives the audio input of the word “wake”, it calculates to obtain that a score of the first evaluation result 108 may be 0.2. At this time, the score of the first evaluation result has not yet reached a threshold score, so the first device will continue to receive the user's subsequent audio input. When the first device 110 continues to receive the audio input of the word “up”, assuming that the score of the first evaluation result 108 accumulates to 0.5 and reaches the threshold score, this means that the device confirms that the pre-wake-up condition is established, and the next action may be performed. If the second word received by the first device 110 is not “up”, e.g., is an unrelated other word, the device will determine that the current audio input does not meet the requirements of the pre-wake-up command, whereupon the score of the target evaluation goes directly from the original 0.2 to zero, and then the first device continues to wait and process a new audio input and perform target evaluation for the next audio input until a speech meeting the wake-up condition is detected.

In some embodiments, the target evaluation of the received audio is performed using an audio processing model built in the first device 110, a core of such a target evaluation being analyzing an audio frame. For example, after an audio input is received by the first device, the first device may divide the continuous audio signal into a plurality of small time segments, i.e., audio frames. Each audio frame typically contains fixed-length audio data (e.g., 20 milliseconds or 50 milliseconds), and this frame division processing manner facilitates improving real-time performance and processing efficiency. Then, the audio processing model built in the first device will extract feature parameters of the speech from each frame, such as Mel-Frequency Cepstral Coefficients, energy, frequency characteristics, etc. These feature parameters may be used to represent core information of the speech. The first device processes the extracted audio features to obtain the first evaluation result. For example, the audio processing model may obtain an evaluation result for a current audio frame according to the audio feature of the current audio frame and scores of previously processed frames, and the evaluation result may also be taken as the first evaluation result of the received audio input. When the first evaluation result is represented by a score, the first evaluation result may be an accumulated score for the already received audio input. When the first evaluation result reaches a preset threshold, the first device will confirm that a pre-wake-up event is triggered. If the accumulated score does not reach the threshold, the first device will receive a new audio input.

The first device 110 compares the first evaluation result 108 with a threshold 112. If the first evaluation result 108 is greater than the threshold 112, this indicates that the currently received audio input is an audio input for the wake-up command.

Therefore, both the received audio input 106 and a subsequent audio input 104, i.e., all of the user's audio input 102, may be provided to the second device 114 to determine whether to wake up the first device 110. When the first evaluation result 108 is greater than the threshold 112, the first device 110 begins transmitting the received audio input 106 to the second device 114; after all the received audio input 106 has been transmitted, the subsequent audio input 104 received continues to be transmitted until all the user's audio input 102 is sent to the second device 104. Then, the second device 114 performs a secondary verification process on the received user audio input 102 to determine whether all the received user audio input 102 is a wake-up instruction 116 of the wake-up command. When the second device 114 receives the subsequent audio input 104, the subsequent audio input 104 also needs to be first transmitted to the first device 110, and then the first device 110 transmits the subsequent audio input 104 to the second device 114.

Finally, if the first device 110 receives from the second device 114 an instruction to wake up the first device 110, the first device 110 is woken up to perform subsequent data processing work. Thus, after the wake-up succeeds, the first device 110 may reply to the user's audio.

By this method, it is possible to, by using the preset pre-wake-up event, begin to transmit the audio to the second device before the user speaks out all the wake-up word, move up the start time of audio transmission, and also move up the end time of audio transmission to the second device, thereby quickly enabling the first device to reply to the user's wake-up word, substantially reducing the time for waiting for the first device to reply, and improving the user's experience.

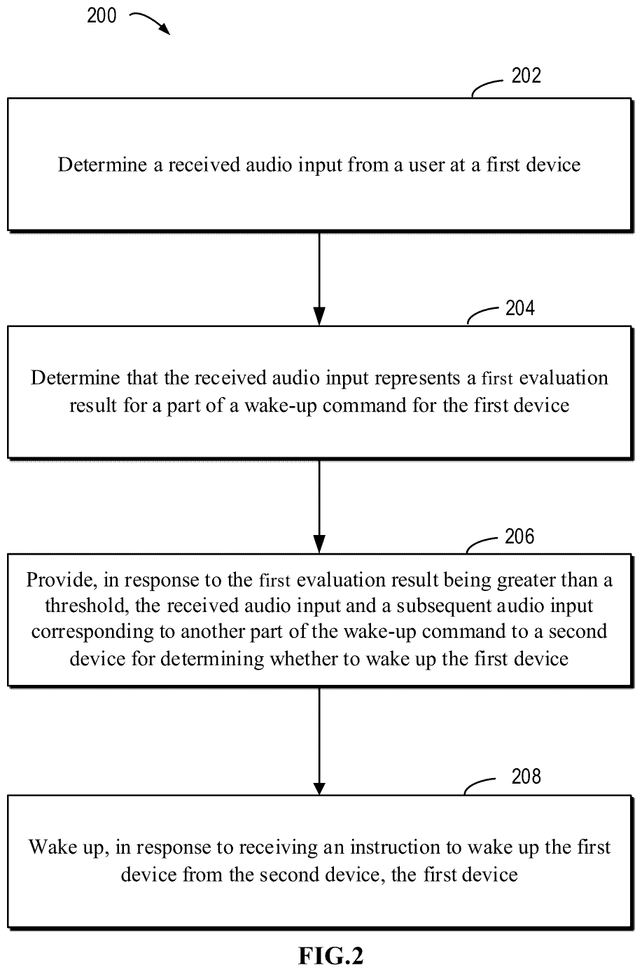

The schematic diagram of an example environment in which an apparatus and/or a method according to some embodiments of the present disclosure may be implemented has already been describe above with reference to FIG. 1. Reference is made below to FIG. 2 to describe a schematic diagram of an example method for waking up a device according to some embodiments of the present disclosure. The method in FIG. 2 may be performed by the first device 110 of FIG. 1 or any suitable computing device.

As depicted in FIG. 2, in an example method 200, at block 202, an audio input already received from a user is determined at a first device. For example, the first device 110 receives a user audio input from the user. The audio input received at this time does not correspond to a complete wake-up command, but to a part of the wake-up command. As shown in FIG. 1, the user's audio input at this time is a received audio input 106, a subsequent audio input 104 for determining the wake-up command has not been received, and the received audio input 106 and the subsequent audio input 104 are sequentially combined into all audio input for the user's wake-up command.

At block 204, it is determined that the received audio input represents a first evaluation result for a part of a wake-up command for the first device. For example, the first device 110 processes an audio frame of the received audio input 106, whereupon the user's audio input has not yet completely finished, so the audio input is considered an incomplete audio input. The received audio part is speech content that the user has spoken and has been successfully received by the first device. The first device 110 may analyze and process this part of audio in real time to evaluate whether it meets a certain pre-set condition (e.g., whether it meets partial features of the wake-up word). The subsequent audio input 104 to be received is speech content that the user has not spoken, and the first device 110 will continue to listen to and receive such audio to complete the processing flow of the entire speech input. The two parts of audio are combined chronologically to finally form the user's all audio input. This stepwise reception and processing design can dynamically respond to the user's input during the speech interaction and improve the real-time processing capability of the device. Furthermore, the device follows up the user input in real time without reducing the fluency of the interaction due to a long waiting time, thereby improving the user's experience.

In some embodiments, upon determining that the received audio input represents the first evaluation result for a part of the wake-up command for the first device, the first device 110 may perform processing for each received audio frame. For example, if the first device 110 receives the last audio frame in the received audio input, the first device 110 may use the last audio frame and a historical evaluation of a previous audio frame in the received audio input to determine the target evaluation for the received audio input at this time. For example, there is an audio processing model in the first device, and the last audio frame in the received audio input is the currently received audio frame, so the audio processing model may calculate, according to the current audio frame and the evaluation result for the previous frame, the first evaluation result for the received audio input after the reception of the current audio frame.

Then, at block 206, in response to the first evaluation result being greater than a threshold, the received audio input and a subsequent audio input corresponding to another part of the wake-up command are provided to the second device to determine whether to wake up the first device. To determine whether the received audio input 106 corresponds to a part of the wake-up command, a threshold 112 is set for determining the received audio input 106. The threshold 112 is a value preset in the first device, and may be adjusted and optimized by later updating of a software level of the first device. The received audio input 106 and the subsequent audio input 104 jointly form all the audio input by the user. For example, since the first device is mostly a wearable device supporting speech interaction, such as a Bluetooth earphone, and does not have a large volume, and therefore has limited computing resources. Therefore, there is only one small wake-up model in the first device 110. In order to ensure a higher wake-up rate and a lower false wake-up rate, audio needs to be transmitted to the second device for secondary verification.

In some embodiments, if the first evaluation result is greater than the threshold, this indicates that the received audio input is highly probably for the wake-up command. Therefore, it is possible to begin to transmit the received audio input to the second device 114 without need to wait for reception of all audio input for the wake-up command. Next, the first device 110 may also continue to receive, from the user, a subsequent audio input corresponding to another part of the wake-up command. Then, the first device 110 also transmits the received subsequent audio input to the second device 114. For convenience of description, the subsequent audio input described above may also be referred to as a first subsequent audio input. If the first evaluation result is less than or equal to the threshold, which indicates it cannot be determined that the received audio input is for a part of the wake-up command, it is necessary to continue to receive a second subsequent audio input. Then, the first device 110 may further determine an evaluation result for the received audio input and the second subsequent audio input according to the received audio input and second subsequent audio input.

In some embodiments, the received audio input 106 and the subsequent audio input 104 are also input to the second device in order of the user audio input. For example, the second device 114 may be a smart mobile phone, and all audio is transmitted to the smart mobile phone for processing by a corresponding application in the second device.

In some embodiments, the second device 114 performs a secondary verification for all the audio transmitted by the first device 110, the secondary verification being a comparative verification performed on the received audio and the wake-up word based on a machine learning model. The machine learning model may be a pre-trained neural network model, such as a convolutional neural network model or a recursive neural network model. In some embodiments, the second device may determine a verification result for all audio based on a predetermined mapping relationship. The foregoing examples are only intended to describe the present disclosure, not to specifically limit the present disclosure.

At block 208, the first device is woken up in response to receiving from the second device an instruction to wake up the first device. For example, if the first device 110 receives from the second device 114 an instruction to wake up the first device 110, an operation of waking up the first device 110 may be performed.

When the second device 114 receives the user's voice input, it is further detected that the user might intend to wake up the first device. For example, the user speaks out the voice content containing the wake-up command in a case where the user is approaching the first device 110 (e.g., a Bluetooth earphone or smart glasses, etc.). The first device forwards the received user audio data or instruction to the second device, and meanwhile records a state of the wake-up operation. This operation ensures that the first device can independently process the user's wake-up intention, and meanwhile retain the flexibility of multi-device collaboration. Upon receiving the user's wake-up command, the second device may further verify the audio content to ensure accuracy and legitimacy of the command. Such a secondary verification typically comprises speech matching and background noise deletion. The speech matching analyzes whether a keyword in the audio matches a preset wake-up word for the first device, and the background noise deletion may filter out interference noise from the environment and improve the accuracy of the verification. If the second device confirms that the audio instruction passes the verification, the verification result will be returned to the first device, attached with corresponding information (such as a state identifier indicating successful wake-up, a user intention, etc.). This step ensures that the first device may respond according to accurate verification information. After receiving the verification-passed result from the second device, the first device will perform a wake-up operation, and switch to an interaction mode to get ready to receive a further instruction from the user. Furthermore, a preset wake-up response (e.g., issuing a speech prompt “the device is already waken up” or turning on an indicator light) is sent to the user to confirm that the wake-up operation is successful. In the scenario of multi-device collaboration, this mechanism may ensure the efficiency and accuracy of the wake-up process, and meanwhile avoid the conflict between multiple devices.

By this method, the audio to be transmitted is transmitted to the second device in advance, the time at which the second device receives all audio is moved up, the result of the secondary verification is returned to the first device more quickly, the first device's response to the use's wakeup command is accelerated, and the user's experience is improved.

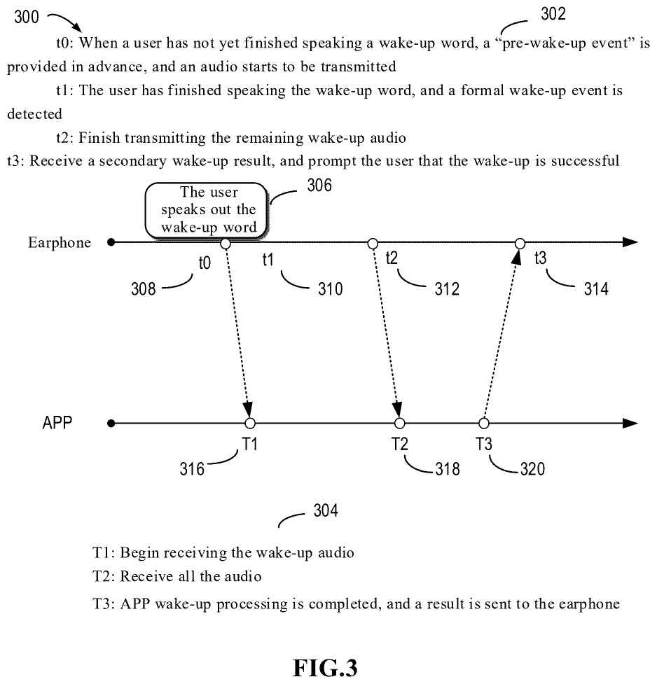

The schematic diagram of an example method for waking up a device according to some embodiments of the present disclosure has been described above with reference to FIG. 3. Reference will be made below to FIG. 3 to describe a schematic diagram of an example process of a device-application interaction flow according to some embodiments of the present disclosure. The earphone in the example process of FIG. 3 may be used as the first device in FIG. 1, and an application (APP) may be an application running on the second device.

In an example 300 is described a schematic diagram of an example process of an earphone-APP interaction flow. t0, t1, t2, and t3 and T1, T2, and T3 respectively represent time nodes in the earphone-application interaction. At block 302, the user speaks a wake-up word, whereupon the user's spoken wake-up word is received at the earphone. The receiving phase is divided into two parts: one part is that the user has already spoken part of the wake-up word, and the other part is that the user has spoken all the wake-up word. The two parts correspond to time t0 and time t1 on the earphone, respectively. At t0, the earphone gives a pre-wake-up event in advance and starts transmitting audio for the wake-up word to the APP; after a short delay via the Bluetooth transmission, the APP on the second device, at T1, starts receiving the audio transmitted at t0.

At t1, after the user has finished speaking all the wake-up word, the earphone has already transmitted a part of the audio to the APP, and then the earphone will continue to send the audio in a time period from t0 to t1 to the APP; at t2, the earphone transmits the user's all the audio via Bluetooth; after a certain transmission time, the APP of the second device receives all the audio at T2. In a time period from T2 to T3, a secondary verification of the incoming audio is performed in the APP of the second device; at T3, the verification process is completed and a result is sent to the earphone. After a certain transmission time, the earphone receives the earphone wake-up result at t3. If it is verified that the received speech corresponds to the wake-up word, a reply to the user's wake-up is sent to represent that the user's wake-up is successful. If it is verified that the received speech does not correspond to the wake-up word, the earphone will not be waken up.

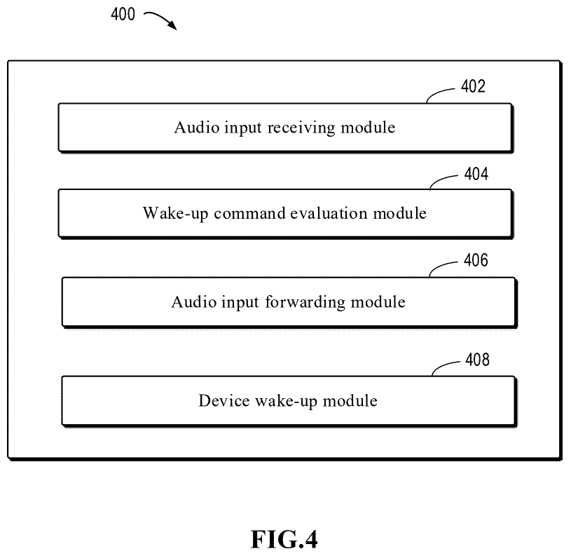

FIG. 4 illustrates a schematic block diagram of an apparatus for waking up a device according to some embodiments of the present disclosure. As shown in FIG. 4, an apparatus 400 comprises an audio input receiving module 402 configured to determine a received audio input from a user at a first device; a wake-up command evaluation module 404 configured to determine that the received audio input represents a first evaluation result for a part of a wake-up command for the first device; an audio input forwarding module 406 configured to, in response to the first evaluation result being greater than a threshold, provide the received audio input and a subsequent audio input corresponding to another part of the wake-up command to the second device to determine whether to wake up the first device; and a device wake-up module 408 configured to wake up the first device in response to receiving from the second device an instruction to wake up the first device.

In some embodiments, the first device is a wearable device, and the second device is a terminal device.

In some embodiments, the wake-up command evaluation module comprises: a last audio frame identification module configured to determine the last audio frame in the received audio input; a first evaluation result calculation module configured to determine the first evaluation result based on the last audio frame and a historical evaluation result for a previous audio frame in the received audio input.

In some embodiments, the wake-up command evaluation module comprises: an audio processing and evaluation module configured to determine the first evaluation result by applying received audio input to an audio processing model.

In some embodiments, the audio input forwarding module comprises: an audio input transmission module configured to transmit the received audio input to the second device in response to the first evaluation result being greater than the threshold; a first subsequent audio reception module configured to receive, from the user, a subsequent audio input corresponding to another part of the wake-up command; a subsequent audio transmission module configured to transmit the subsequent audio input to the second device.

In some embodiments, the audio input forwarding module comprises: a second subsequent audio receiving module configured to continue to receive a second subsequent audio input in response to the first evaluation result being less than or equal to the threshold; an audio evaluation result calculation module configured to determine an evaluation result for the received audio input and the second subsequent audio input based on the received audio input and the second subsequent audio input.

In some embodiments, the second device determines whether to wake up the first device based on the received audio input and the subsequent audio input.

In some embodiments, the audio input forwarding module further comprises: a Bluetooth transmission module configured to provide the received audio input and the subsequent audio input to the second device via Bluetooth communication.

In some embodiments, the second device processes the received audio input and the subsequent audio input using a machine learning model

In some embodiments, the wake-up command is a sentence or word.

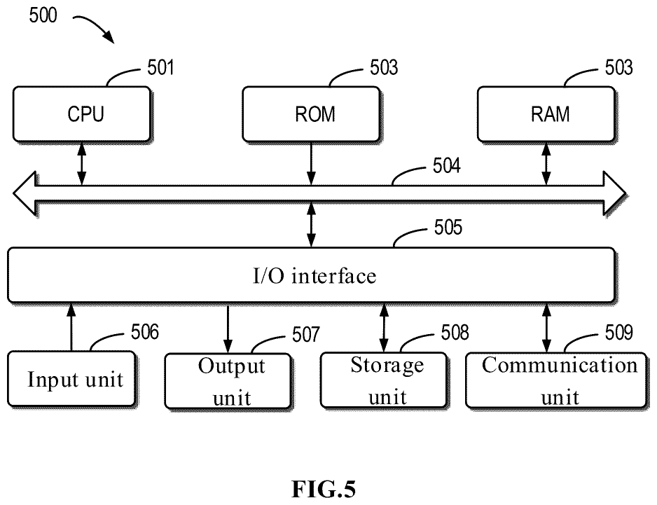

FIG. 5 illustrates a schematic block diagram of an example device 500 for implementing embodiments of the present disclosure. A first device 110 and a second device 114 in FIG. 1 may be implemented using the apparatus 500. As shown in FIG. 5, the device 500 comprises a Central Processing Unit (CPU) 501 which may perform various suitable acts and processes in accordance with a computer program instruction stored in a Read Only Memory (ROM) 502 or a computer program instruction loaded from a storage unit 508 into a Random Access Memory (RAM) 503. In the RAM 503, various programs and data needed by the operation of the device 500 are also stored. The CPU 501, the ROM 502, and the RAM 503 are connected to one another via a bus 504. An input/output (I/O) interface 505 is also coupled to the bus 504.

A plurality of components in the device 500 are connected to the I/O interface 505, and include: an input unit 506, such as a keyboard, a mouse, etc.; an output unit 507 such as various types of displays, speakers, and the like; a storage unit 508, such as a magnetic disk, an optical disk, etc.; and a communication unit 509 such as a network card, a modem, a wireless communication transceiver, etc. The communication unit 509 allows the device 500 to exchange information/data with other devices over a computer network such as the Internet and/or various telecommunication networks.

The various methods or processes such as method 200 and process 300 described above may be performed by the processing unit 501. For example, in some embodiments, the method 300 and process 400 may be implemented as a computer software program tangibly embodied on a machine-readable medium, such as storage unit 508. In some embodiments, part or all of the computer program may be loaded and/or installed on the device 500 via ROM 502 and/or communication unit 509. One or more acts in the example method 200 and process 300 described above may be performed when the computer program is loaded into the RAM 503 and executed by the CPU 501.

The present disclosure may relate to methods, apparatuses, systems and/or computer program products. The computer program product may include a computer readable storage medium having computer readable program instructions embodied thereon for performing various aspects of the present disclosure.

The computer-readable storage medium may be a tangible device that can hold and store instructions for use by an instruction execution device. The computer readable storage medium may be, for example but not limited to, an electrical storage device, a magnetic storage device, an optical storage device, an electromagnetic storage device, a semiconductor storage device, or any suitable combination of the above. A non-exhaustive list of more specific examples of the computer readable storage medium comprises the following: a portable computer diskette, a hard disk, a Random Access Memory (RAM), a Read-Only Memory (ROM), an Erasable Programmable Read-Only Memory (EPROM or flash memory), a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, etc., and conventional procedural programming languages such as “C” language or a similar programming language. The computer readable program instructions may execute entirely on the user's computer, partly on the user's computer, as a stand-alone software package, partly on the user's computer and partly on a remote computer or entirely on the remote computer or server. In the case of the remote computer, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, Field-Programmable Gate Arrays (FPGA), or Programmable Logic Arrays (PLA) may execute the computer readable program instructions by utilizing state information of the computer readable program instructions to personalize the electronic circuitry, in order to implement aspects of the present disclosure.

Aspects of the present invention are described herein with reference to flowchart illustrations and/or block diagrams of methods, apparatus (systems), and computer program products according to embodiments of the invention. It should be appreciated that each block of the flowchart illustrations and/or block diagrams, and combinations of blocks in the flowchart illustrations and/or block diagrams, may be implemented by computer readable program instructions.

These computer readable program instructions may be provided to a processing unit of a general-purpose computer, special-purpose computer, or other programmable data processing apparatus to produce a machine, such that the instructions, which executed via the processing unit of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable data processing apparatus or other device to produce a computer implemented process, such that the instructions executed on the computer, other programmable data processing apparatus, or other device implement the functions/acts specified in one or more blocks in the flowcharts and/or block diagrams.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or part of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special-purpose hardware and computer instructions.

The depictions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for waking up a device, comprising:
determining a received audio input from a user at a first device;
determining that the received audio input represents a first evaluation result for a part of a wake-up command for the first device;
providing, in response to the first evaluation result being greater than a threshold, the received audio input and a subsequent audio input corresponding to another part of the wake-up command to a second device for determining whether to wake up the first device; and
waking up, in response to receiving an instruction to wake up the first device from the second device, the first device.

2. The method according to claim 1, wherein the first device is a wearable device, and the second device is a terminal device.

3. The method according to claim 1, wherein determining that the received audio input represents the first evaluation result for the part of the wake-up command for the first device comprises:
determining the last audio frame in the received audio input; and
determining the first evaluation result based on the last audio frame and a historical evaluation result for a previous audio frame in the received audio input.

4. The method according to claim 1, wherein determining that the received audio input represents the first evaluation result for the part of the wake-up command for the first device comprises:
determining the first evaluation result by applying received audio input to an audio processing model.

5. The method according to claim 1, wherein providing the received audio input and the subsequent audio input corresponding to another part of the wake-up command to the second device comprises:
in response to the first evaluation result being greater than the threshold, transmitting the received audio input to the second device; and
receiving, from the user, the subsequent audio input corresponding to another part of the wake-up command; and
transmitting the subsequent audio input to the second device.

6. The method according to claim 1, wherein the subsequent audio input is a first subsequent audio input, and the method further comprises:
in response to the first evaluation result being less than or equal to the threshold, continuing to receive a second subsequent audio input; and
determining an evaluation result for the received audio input and the second subsequent audio input based on the received audio input and the second subsequent audio input.

7. The method according to claim 1, wherein the second device determines whether to wake up the first device based on the received audio input and the subsequent audio input.

8. The method according to claim 7, wherein the second device processes the received audio input and the subsequent audio input by using a machine learning model.

9. The method according to claim 1, wherein providing the received audio input and the subsequent audio input corresponding to another part of the wake-up command to the second device comprises:
providing the received audio input and the subsequent audio input to the second device via Bluetooth communication.

10. The method according to claim 1, wherein the wake-up command is a sentence, a phrase, or a word.

11. An electronic device, comprising:
one or more processors;
a storage device for storing one or more programs, wherein,
the one or more programs, when executed by the one or more processors, cause the one or more processors to:
determine a received audio input from a user at a first device;
determine that the received audio input represents a first evaluation result for a part of a wake-up command for the first device;
in response to the first evaluation result being greater than a threshold, provide the received audio input and a subsequent audio input corresponding to another part of the wake-up command to a second device to determine whether to wake up the first device; and
in response to receiving an instruction to wake up the first device from the second device, wake up the first device.

12. The device according to claim 11, wherein the first device is a wearable device, and the second device is a terminal device.

13. The device according to claim 11, wherein the one or more programs causing the one or more processors to determine that the received audio input represents the first evaluation result for the part of the wake-up command for the first device comprise instructions to:
determine the last audio frame in the received audio input; and
determine the first evaluation result based on the last audio frame and a historical evaluation result for a previous audio frame in the received audio input.

14. The device according to claim 11, wherein the one or more programs causing the one or more processors to determine that the received audio input represents the first evaluation result for the part of the wake-up command for the first device comprise instructions to:
determine the first evaluation result by applying received audio input to an audio processing model.

15. The device according to claim 11, wherein the one or more programs causing the one or more processors to provide the received audio input and the subsequent audio input corresponding to another part of the wake-up command to the second device comprise instructions to:
in response to the first evaluation result being greater than the threshold, transmit the received audio input to the second device; and
receive, from the user, the subsequent audio input corresponding to another part of the wake-up command; and
transmit the subsequent audio input to the second device.

16. The device according to claim 11, wherein the subsequent audio input is a first subsequent audio input, and the one or more programs further causing the one or more processors to:
in response to the first evaluation result being less than or equal to the threshold, continue to receive a second subsequent audio input; and
determine an evaluation result for the received audio input and the second subsequent audio input based on the received audio input and the second subsequent audio input.

17. The device according to claim 11, wherein the second device determines whether to wake up the first device based on the received audio input and the subsequent audio input.

18. The device according to claim 17, wherein the second device processes the received audio input and the subsequent audio input by using a machine learning model.

19. The device according to claim 11, wherein the one or more programs causing the one or more processors to provide the received audio input and the subsequent audio input corresponding to another part of the wake-up command to the second device comprise instructions to:
providing the received audio input and the subsequent audio input to the second device via Bluetooth communication,
wherein the wake-up command is a sentence or a word.

20. A non-transitory storage medium containing computer-executable instructions, wherein the computer-executable instructions, when executed by one or more computer processors, are used to cause the one or more computer processors to:
determine a received audio input from a user at a first device;
determine that the received audio input represents a first evaluation result for a part of a wake-up command for the first device;
in response to the first evaluation result being greater than a threshold, provide the received audio input and a subsequent audio input corresponding to another part of the wake-up command to a second device to determine whether to wake up the first device; and
in response to receiving an instruction to wake up the first device from the second device, wake up the first device.
